(19) United States
(12) Patent Application Publication
(10) Pub. No.: US 2005/0134878 A1
(43) Pub. Date: Jun. 23, 2005

(54) Printing system, print data generating method, and program

(75) Inventor: Kazuhisa Ebuchi, Kanagawa (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/991,606

(22) Filed: Nov. 17, 2004

(30) Foreign Application Priority Data
Nov. 27, 2003 (JP) 2003-397206
Sep. 15, 2004 (JP) 2004-268341

(51) Int. Cl. H04N 1/387; G06K 15/02; G06F 3/12

(52) U.S. Cl. 358/1.9; 283/74; 715/700; 358/3.28; 358/450; 358/1.18

(57) ABSTRACT

A printing system includes an application and a user interface driver. The user interface driver generates resultant page data by adding pattern data to page data on the basis of a start instruction from the application. The application adds document text data to the resultant page data in which the pattern data is added by the user interface driver. Logic page data is not generated independently of the user's intention, thus a mismatch between the number of pages displayed in a print queue display utility and the number of pages actually printed is prevented.

### BACKGROUND OF THE INVENTION

1. Field of the Invention

The present invention relates to a printing system and a print data generating method, which are capable of adding a pattern to document text and printing the resultant document text, and a program thereof.

2. Description of the Related Art

To distribute printouts each including print data for information transmission and print data for function display, for example, to distribute documents to be used for internal consumption only, in some cases, a stamp is put on each page of each document to print text, e.g., “Confidential”. However, manually putting a stamp on each page of each printed material is time consuming, and therefore costly. Furthermore, such manual stamping is more prone to error (missing stamping of pages). Therefore, a first approach to printing an electronic mark of “Confidential” simultaneously with document text is generally used.

To print document text with a stamp according to the first approach, an application includes an input unit, through which a user enters a desired character string as a stamp. In the printing operation, when the application produces print data of each page of a document, the application combines data of the stamp, specified by the user, with the print data, and then transmits the resultant data to a printer. To reduce a load on the application, a second approach provides a printer driver with a stamp function. According to the second approach, for example, the operation of the printer driver is interrupted by a command generated during the operation thereof, a sub-application is executed to create stamp data, the stamp data is transmitted to the printer driver, and after that, the printer driver superimposes the stamp data on print data of each document text page. Japanese Patent Laid-Open No. 2002-333959 discloses a third approach using print events generated in printing by a printing system. According to the third approach, in response to a print event generated from an application, a user interface driver creates page data including stamp data in place of the application. The stamp page data is inserted into document text page data produced by the application and all of the data is stored in a spool file as a standard format of the system. The stamp page data and the document text page data are despooled from the spool file and a printer processor superimposes the stamp page data on the document text page data to produce print data. A printer graphics driver converts the print data into bitmap data and then supplies the bitmap data to a printer.

According to the second approach, assuming that an application produces print data on the client side in a network and a printer driver operates on the server side, if a user specifies a stamp and a desired font but the server does not have the specified font, the document cannot be printed out with the stamp. Regarding the stamp, in many cases, it is required to print various marks, a box, or an image in addition to a character string on a sheet of paper and then print document text thereon. In the following description, the character string, the marks, the box, or the image will be collectively called a pattern.

According to the third approach provided in order to overcome the disadvantages of the second approach, logic page data (stamp page data) is inserted into print data (document text page data) independently of the user's intention. Consequently, the number of pages recognized by the system, i.e., the number of pages displayed in a print queue display utility differs from what the user expects. For example, it is assumed that stamp data including “Confidential” of one page is inserted into print data of a five-page document. Although the user expects that the total number of pages is five, the print queue display utility shows that the total number of pages of the corresponding print job is six (1+5). The user interface driver includes an operation unit through which the user utilizes the stamp function. When the user uses this function, the user interface driver inserts page data of a pattern into document text page data and the print processor combines the pattern page data with the document text page data. Actually, the user has to operate both of the user interface driver and the print processor supporting the stamp function. In such a case, respective modules perform cooperative processing therebetween and process inserted logic page data with complicated handling.

### SUMMARY OF THE INVENTION

The present invention provides a print data generating method and a printing system that are capable of printing an image of print data including print data for information transmission (text) and print data for function display (e.g., a stamp of “Confidential”) even when a server does not include a necessary font. According to the method and system, the number of pages displayed in a print queue display utility matches the number of pages to actually be printed. Further, it is unnecessary for modules to perform cooperative processing therebetween. Thus, the method and system can easily be realized.

According to an aspect of the present invention, a printing system includes: an application; and a user interface driver. The user interface driver generates patterned page data by adding pattern data to page data in response to an event generated from an operating system based on a start instruction from the application. The application adds document text data to the patterned page data.

According to another aspect of the present invention, a printing system includes: an application; and a user interface driver. The application generates document page data by adding document text data to page data. The user interface driver adds pattern data to the document page data, in response to an event generated from an operating system based on an end instruction from the application.

According to another aspect of the present invention, a print data generating method includes: receiving an event based on a start instruction generated from an application from an operating system; and adding pattern data to page data based on the received event.

According to still another aspect of the present invention, a print data generating method includes: receiving an event based on an end instruction generated from an application from an operating system; and adding pattern data to page data, in which document text data is applied by an application, based on the received event.

According to the present invention, a print event generated in the printing system is enhanced. The user interface driver utilizes the enhanced print event to directly add pattern data to a proper position in print data of each page at proper timing.

Further features and advantages of the present invention will become apparent from the following description of the embodiments with reference to the attached drawings.

### BRIEF DESCRIPTION OF THE DRAWINGS

FIG. 1 is a block diagram of a printing system according to the present invention.

FIG. 2 is a flowchart of a process of printing a pattern behind document text.

FIG. 3 is a flowchart of a process of printing a pattern on top of document text.

FIG. 4 shows examples of printouts based on generated data.

FIG. 5 shows a display example of a user interface driver having a function of printing a pattern on top of document text created by an application.

FIG. 6 shows a display example of a user interface driver having an input setting unit that can switch between functions according to first and second embodiments.

FIG. 7 is a block diagram of the hardware configuration of the printing system according to the present invention.

### DESCRIPTION OF THE EMBODIMENTS

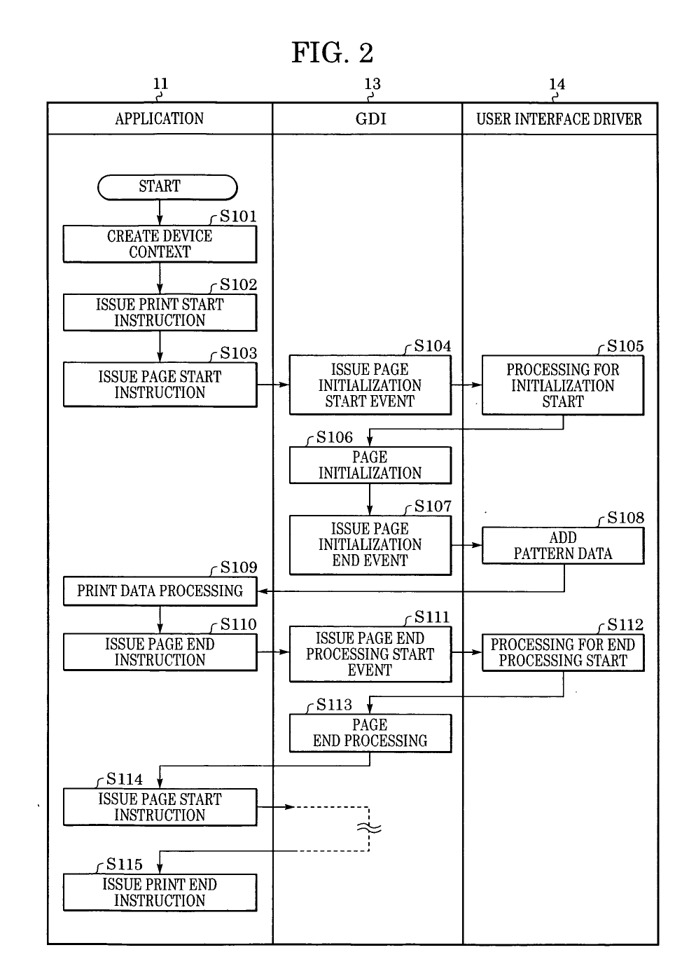

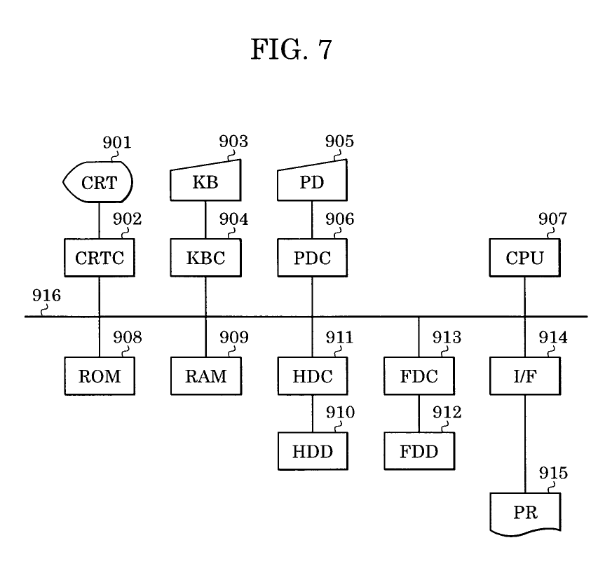

FIG. 7 is a block diagram of the hardware configuration of a printing system according to the present invention. Referring to FIG. 7, the printing system includes: a CRT display 901; a CRT controller (CRTC) 902; a data input device 903, e.g., a keyboard (KB); a keyboard controller (KBC) 904; a coordinate input device 905, e.g., a pointing device (PD); a pointing device controller (PDC) 906; a central processing unit (CPU) 907; a read-only memory (ROM) 908; a random-access memory (RAM) 909; a hard disk drive (HDD) 910; a hard disk controller (HDC) 911; a floppy disk drive (FDD) 912; a floppy disk controller (FDC) 913; an interface (I/F) 914; a printer (PR) 915; and a bus 916. The CRT display 901 displays a print setting dialog box provided by a user interface driver shown in FIG. 2. The CPU 907 controls the whole system. The ROM 908 stores a boot program. The RAM 909 stores an operating system (OS), various application programs, and a printer driver program. The RAM 909 also functions as a work area. The HDD 910 stores the OS, the various application programs, the print driver program, and font data, and further, temporarily stores a spool file. The FDD 912 drives a portable recording medium. The I/F 914 connects to the printer 915, such as an inkjet printer, through an interface cable. The bus 916 connects the above devices to each other. When the present system is turned on, the CPU 907 starts up according to the boot program stored in the ROM 908, loads the OS from the HDD 910, and then enters a user operation standby mode. When the CPU 907 receives a print command or a printer-driver print-setting change command entered from the KB 903 or the PD 905 by a user through the application. Alternatively, if the system is set so that the printer driver program automatically starts up, the printer driver program stored in the HDD 910 is loaded into the RAM 909 and is then executed.

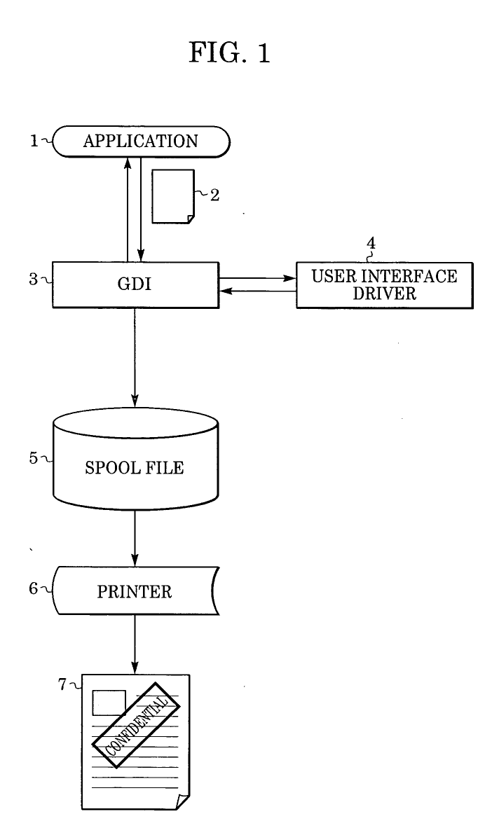

Examples of software control according to the present invention are described next. FIG. 1 is a block diagram of the printing system according to the present invention. Referring to FIG. 1, the present invention relates to two modules, i.e., a graphics device interface (GDI) 3 and a user interface driver 4. The GDI 3 issues an event to the user interface driver 4 in processing data of each page to be printed at proper timing. The user interface driver 4 serves as a pattern setting unit and a pattern data generating unit. In this instance, the GDI is one of modules constituting the kernel of Windows®, the Microsoft® operating system. The GDI is concerned with graphics drawing. In this description, Windows® is used as an operating system. The present invention is not limited to the case so long as a target operating system has a similar mechanism.

The system in FIG. 1 is designed such that document print data created by an application 1 through a personal computer as a host processor is temporarily stored as a spool file 5 in a storage device such as a hard disk through the GDI 3 and the data is then supplied to a printer 6 to print a document. The spool file 5 may be directly produced by the GDI 3. Alternatively, the spool file 5 can also be generated by a module (not shown), e.g., a print provider.

Before the GDI 3 initializes page data 2 generated by the application 1 on the basis of a processing start instruction for each page generated by the application 1, the GDI 3 generally issues an event indicative of the start of page data initialization to the user interface driver 4. Additionally, before the GDI 3 performs end processing of the page data 2, in which print data has been written by the application 1, on the basis of a processing end instruction for each page data generated by the application 1, the GDI 3 issues an event indicative of the start of page data end processing (page end processing) to the user interface driver 4.

The user interface driver 4 generally has a function for setting print paper size, print direction, and other attributes. Further, the user interface driver 4 according to the present invention includes a pattern setting unit for setting the attribute of a pattern, e.g., a stamp. For pattern setting, whether a target pattern is printed behind or on top of document text to be produced can be determined.

Printing Pattern behind Document Text

According to the present invention, after completion of the initialization of the page data 2, the GDI 3 further issues an event indicative of the end of page data initialization to the user interface driver 4 prior to returning the initialized page data 2 and control to the application 1.

On condition that the user sets the attribute of pattern data such that a pattern is printed behind document text, when receiving the event indicating the end of the initialization of the page data 2, the user interface driver 4 adds pattern data to the initialized page data 2 and then returns the resultant page data 2 including the pattern data to the GDI 3 and the application 1.

The application 1 performs normal print data processing to the resultant page data 2 in which the pattern data has been added, thus generating print data in which the pattern is arranged behind document text.

Data of all pages generated is stored as an enhanced metafile (EMF) spool file 5 through, e.g., the GDI 3. EMF is a mechanism for enhancing the speed of printing in a Windows® environment. Subsequently, a print processor (not shown) reads print output information and the print data from the EMF spool file 5 and then supplies every page of the print data to a printer graphics driver (not shown) through the GDI 3. The printer graphics driver serving as an image generating unit produces bitmap data to be processed by the printer on the basis of the print data of each composite page data supplied from the print processor in response to a graphic drawing command generated by the GDI 3. The printer graphics driver supplies the produced bitmap data to the printer 6 through a data transmission unit (not shown). The printer 6, serving as an output device, prints a document image in which the pattern is applied behind the document text, onto a sheet of paper 7 on the basis of the bitmap data supplied from the printer graphics driver.

FIG. 2 shows a flowchart of a process of printing a pattern behind document text according to the present invention. The process is stored in the ROM or the HDD as a program including steps related to an application 11, a GDI (operating system) 13, and a user interface driver 14. The application 11 creates a device context in step S101. The device context is a Windows® mechanism that is introduced for handling a display or a printer as a virtual display device. Specifically, the device context is a data structure including a set of device information. A Windows® application can perform a drawing process (print data processing) to the device context without concern for a specific device. In the following explanation, print data processing is performed through the device context. Subsequently, the application 11 starts printing in step S102. In step S103, the application 11 issues an instruction (page start instruction) to start generating print data of a first page. In response to the page start instruction from the application 11, in step S104, the GDI 13 issues an event (page initialization start event) indicating the start of page data initialization, i.e., initialization start timing to the user interface driver 14 prior to starting to initialize the page data. In response to the event, in step S105, the user interface driver 14 performs initialization processing to be executed upon starting the page data initialization. Generally, known systems each perform the above event issue and user interface processing associated with the event issue. Special processing is not necessarily performed. After the initialization processing is finished by the user interface driver 14, the GDI 13 initializes the page data in step S106. According to the present invention, after completion of the page data initialization, in step S107, the GDI 13 issues an event (page initialization end event) indicating the end of the initialization to the user interface driver 14.

According to the present invention, in response to the event, in step S108, the user interface driver 14 adds pattern data to the initialized page data to generate resultant page data corresponding to the first page, the resultant page data including the pattern data. When receiving the resultant page data in which the pattern data has been added, in step S109, the application 11 performs the normal print data processing to the resultant page data to generate print data of the first page, the print data including the pattern data and normal document text data. After completion of the generation, the application 11 issues a page data generation end instruction (page end instruction) in step S110. After completion of end processing for page data generation (page end processing) in steps S111 to S113, the application 11 again starts to generate print data of the next page. After the generation of print data of all pages is finished, the application 11 issues a print end instruction. Processing in the application 11 then terminates.

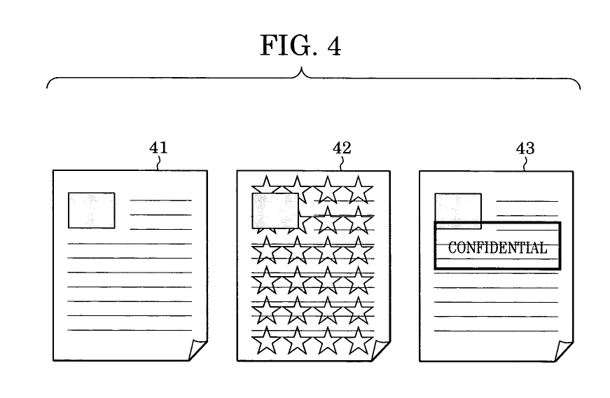

FIG. 4 shows examples of printouts based on generated data. A normal printout 41 has no pattern. A printout 42 includes a pattern behind document text, the pattern being applied through the system according to the present invention.

Printing Pattern on Top of Document Text

Prior to performing end processing of page data 2 subjected to the normal print data processing by the application 1, the GDI 3 generates an event indicating the start of the page end processing to the user interface driver 4.

On condition that the user sets the attribute of pattern data such that a pattern is printed on top of document text, when the user interface driver 4 receives an event indicating the completion of the normal print data processing by the application 1, the user interface driver 4 according to the present invention adds pattern data to the page data 2 subjected to the normal print data processing and then returns the resultant page data 2 including the pattern data to the GDI 3. The GDI 3 performs the page end processing to the resultant page data 2 to generate print data. Thus, the generation of the print data of the corresponding page is completed.

In a manner similar to the printing of a pattern behind document text, generated data of all pages is stored as an EMF spool file 5 through, for example, the GDI 3. Subsequently, the print processor (not shown) reads print output information and the print data from the EMF spool file 5 and then supplies print data for every page to the printer graphics driver (not shown) through the GDI 3. The printer graphics driver serving as the image generating unit produces bitmap data based on the print data of each composite page supplied from the print processor in response to a graphic drawing command generated by the GDI 3. The printer graphics driver supplies the produced bitmap data to the printer 6 through the data transmission unit (not shown). The printer 6, serving as the output device, prints a document image in which a pattern is arranged on top of document text, onto a sheet 7 based on the bitmap data supplied from the printer graphics driver.

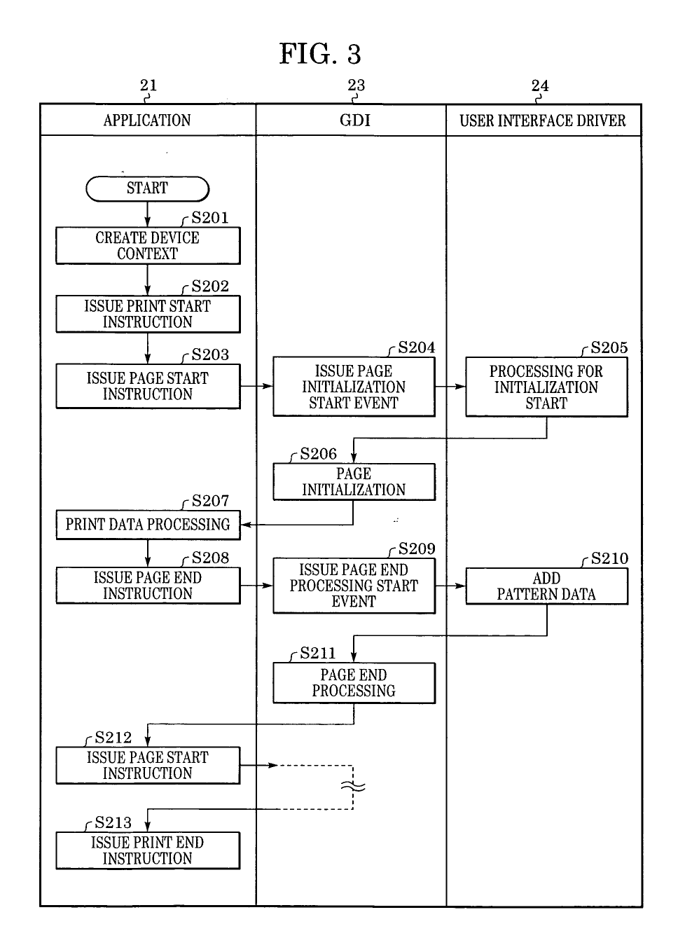

FIG. 3 shows a flowchart of a process of printing a pattern on top of document text according to the present invention. The process is stored in the ROM or the HDD as a program including steps related to an application 21, a GDI (operating system) 23, and a user interface driver 24. In step S201, the application 21 creates a device context. Subsequently, the application 21 starts printing in step S202. In step S203, the application 21 issues an instruction (print start instruction) to start generating print data of a first page. After completion of page data initialization in steps S204 to S206, when receiving the initialized page data, in step S207, the application 21 performs normal print data processing to the page data to generate normal print data of the first page, the normal print data including document text data. After completion of the generation of the print data, the application 11 issues a page data generation end instruction (page end instruction) in step S208.

According to the present invention, in response to the instruction, the GDI 23 issues an event (page end processing start event) indicating the start of page end processing to the user interface driver 24 in step S209 prior to starting the end processing. Further, according to the present invention, in response to the event, in step S210, the user interface driver 24 adds pattern data to the print data, obtained by performing the normal print data processing to the page data by the application 21, to generate resultant print data of the first page, the print data including the document text data and the pattern data. After completion of the addition of the pattern data, in step S211, the GDI 23 performs the page end processing. Subsequently, the application 21 again starts to produce print data of the next page. After completion of the generation of print data of all pages, the application 21 issues a print end instruction. Processing in the application 21 then terminates.

FIG. 4 shows examples of printouts based on generated data. The normal printout 41 has no pattern. A printout 43 includes a pattern on top of document text, the pattern being added through the system according to the present invention.

Embodiments of the present invention are described below.

### First Embodiment

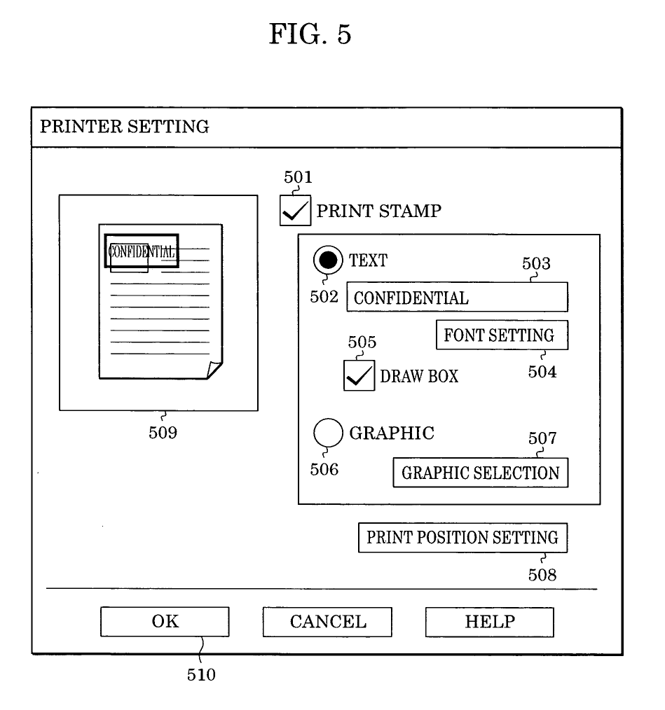

FIG. 5 shows an example of a user interface output by a user interface driver having a function of printing a pattern on top of document text produced by an application. The present interface driver includes a print setting input unit related to a pattern, e.g., a stamp to be printed on top of document text. The user can use controls on the user interface, to specify inclusion of a stamp (print stamp control checkbox 501) and attributes of the stamp, such as text to be included in the stamp. For example, it is assumed that the user marks a radio button 502 to print text as a stamp. The user enters the desired stamp text in a text box 503. After that, the user clicks a button 504 to display another window, where the user can specify the font type of the text. A checkbox 505 may be provided as an additional function, so that the user can draw a box around the text in the text box 503. If the user selects a radio button 506 instead of the radio button 502, the user clicks a button 507 to display another window, where the user can select an image file from among image files stored in the memory device and then print the selected image file as a stamp. Further, the user clicks a button 508 to display another window, where the user can specify the position of the stamp on a sheet of paper. After the user completes the print setting, the user can see a preview in a window 509. When the user clicks an OK button 510 to confirm the stamp print setting entered by the user, the present user interface driver receives an event indicating the start of page end processing from the GDI and then applies pattern data of the stamp based on the setting to page data to be immediately subjected to end processing. On the basis of generated print data, the printer produces a printout in which the stamp based on the user setting is applied on top of document text.

### Second Embodiment

Regarding the checkbox 501 of the print setting input unit in the user interface driver according to the first embodiment, instead of the function of printing a pattern on top of document text, a function of printing a pattern behind document text can be provided for the print setting input unit, thus realizing a user interface driver having a function of applying specified data behind document text. In this case, when the user clicks the OK button 510 to confirm background print setting entered by the user, the present user interface driver receives an event indicating the end of the page data initialization from the GDI and then applies a background pattern based on the setting to initialized page data. On the basis of generated print data, the printer produces a printout in which the pattern is applied behind document text according to the user setting.

### Third Embodiment

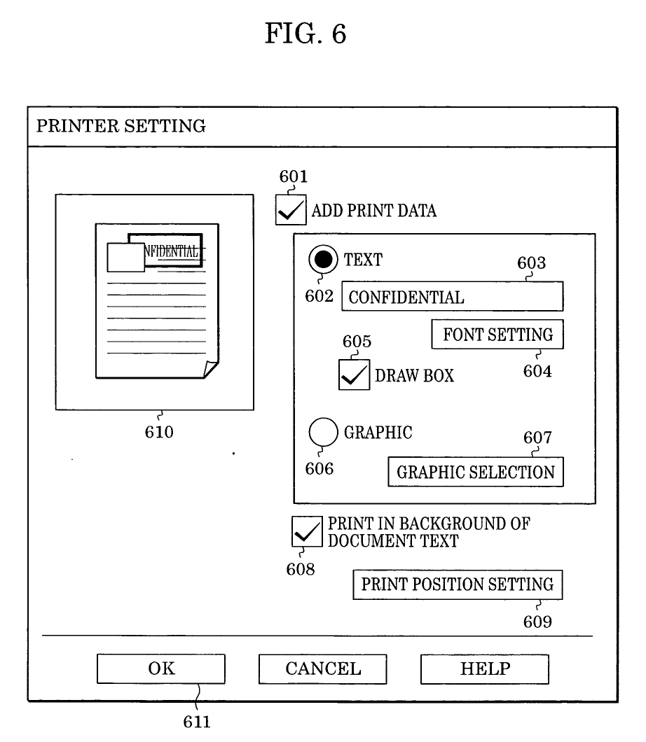

FIG. 6 shows an example of a user interface output by a user interface driver having a print setting input unit that can switch between the functions according to the first and second embodiments. According to the print setting input unit of the present user interface driver, the user selects “ADD PRINT DATA” in a checkbox 601 and specifies the type, position, and other attributes of specified data with buttons 602 to 604, a checkbox 605, and buttons 606, 607, and 609. Further, the user can determine whether the specified data to be added is applied on top of or behind document text using a checkbox 608. If the checkbox 608 is checked, the user interface driver according to the present invention applies the specified data to the page data when the GDI issues the page initialization end event. If the checkbox 608 is not checked, the user interface driver adds the specified data to the page data when the GDI issues the page end processing start event. On the basis of generated print data, the printer produces a printout in which a pattern based on the user setting is added on top of or behind document text.

### Fourth Embodiment

Instead of or in addition to the setting functions of the first to third embodiments, a user interface driver can have a function of adding pattern data to page data of only the first page or a specified page of a plurality of pages.

### Fifth Embodiment

Instead of or in addition to the setting functions of the first to fourth embodiments, a user interface driver can have a function of storing the attribute of a set pattern to easily reproduce the same pattern later. Alternatively, the user interface driver may have a function of preparing text patterns and image patterns and allowing the user to select a favorite pattern.

### Sixth Embodiment

Instead of or in addition to the setting functions of the first to fourth embodiments, a user interface driver can have a function of selecting a print mode from various modes, e.g., printing a set pattern in a tiling manner or zooming in or out the set pattern to print the resultant pattern.

### Other Embodiments

So long as a user interface driver has the same functions as those in the foregoing embodiments, the user interface driver to be displayed is not limited to those in FIGS. 5 and 6.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application Nos. 2003-397206 filed Nov. 27, 2003 and 2004-268341 filed Sep. 15, 2004, which are hereby incorporated by reference herein.

1. A printing system comprising:
an application; and
a user interface driver that generates patterned page data by adding pattern data to page data in response to an event generated from an operating system based on a start instruction from the application,
wherein the application generates resultant page data by adding document text data to the patterned page data generated by the user interface driver.

2. The printing system according to claim 1, further comprising:
a printer graphics driver that produces bitmap data based on the resultant page data and supplies the bitmap data to a printer.

3. A printing system comprising:
an application; and
a user interface driver, wherein
the application generates document page data by adding document text data to page data, and
the user interface driver generates resultant page data by adding pattern data to the document page data generated by the application in response to an event generated from an operating system based on an end instruction from the application.

4. The printing system according to claim 3, further comprising:
a printer graphics driver for producing bitmap data based on the resultant page data and supplying the bitmap data to a printer.

5. A print data generating method comprising:
receiving an event based on a start instruction generated from an application from an operating system; and
generating resultant page data by adding pattern data to page data based on the event received.

6. A computer-readable medium including computer-executable instructions for performing the print data generating method according to claim 5.

7. The print data generating method according to claim 5, further comprising:
producing bitmap data based on the resultant page data; and
supplying the bitmap data to a printer.

8. A computer-readable medium including computer-executable instructions for performing the print data generating method according to claim 7.

9. A print data generating method comprising:
receiving an event based on an end instruction generated from an application from an operating system; and
generating resultant page data by adding pattern data to page data, in which document text data is applied by an application, based on the received event.

10. A computer-readable medium including computer-executable instructions for performing the print data generating method according to claim 9.

11. The print data generating method according to claim 9, further comprising:
producing bitmap data based on the resultant page data; and
supplying the bitmap data to a printer.

12. A computer-readable medium including computer-executable instructions for performing the print data generating method according to claim 11.

13. A print data generating method comprising:
issuing a start instruction; and
adding document text data to page data, in which pattern data is applied by a driver, based on the start instruction.

14. A computer-readable medium including computer-executable instructions for performing the print data generating method according to claim 13.

15. A print data generating method comprising:
generating resultant page data by applying document text data to page data; and
issuing an end instruction in order to allow a driver to add pattern data to the resultant page data including the document text data.

16. A computer-readable medium including computer-executable instructions for performing the print data generating method according to claim 15.
